(19) United States
(12) Patent Application Publication
(10) Pub. No.: US 2022/0029198 A1
(43) Pub. Date: Jan. 27, 2022

(54) CONDUCTIVE POLYMER ELECTROLYTE FOR BATTERIES

(71) Applicant: Arkema France, Colombes (FR)

(72) Inventors: Manuel HIDALGO, PIERRE-BENITE CEDEX (FR); Dominique PLEE, COLOMBES CEDEX (FR)

(73) Assignee: Arkema France, Colombes (FR)

(21) Appl. No.: 17/298,145

(22) PCT Filed: Nov. 28, 2019
(86) PCT No.: PCT/EP2019/082968

§ 371 Date: May 28, 2021

(30) Foreign Application Priority Data
Nov. 30, 2018 (FR) 1872144

(51) Int. Cl. H01M 10/0565; H01M 10/0525; C08J 5/18; H01M 50/497; H01M 50/431; C08L 27/18

(52) U.S. Cl. CPC H01M 10/0565; H01M 10/0525; C08J 5/18; H01M 50/497; H01M 50/426; C08L 27/18; H01M 2300/0082; H01M 2300/0085; H01M 50/431

(57) ABSTRACT

The present invention relates to a solid polymer electrolyte in the form of an organic-organic composite material, intended to be used in a lithium-polymer battery. The invention also relates to a process for manufacturing such an electrolyte. This electrolyte is notably intended for making a lithium-polymer battery or an “all-solid” battery, notably as regards the ion-conducting separator. The invention thus also relates to a battery separator comprising such a polymer electrolyte, to processes for manufacturing same and to the battery incorporating this electrolyte.

### TECHNICAL FIELD

The present invention relates to the field of lithium batteries, and more particularly lithium-polymer batteries and batteries known as “all-solid” batteries. These batteries can include in the electrolyte alkali metal cations such as Na or Li, alkaline-earth metal cations such as Ca or Mg, or, finally, aluminum.

More particularly, the invention relates to a solid polymer electrolyte in the form of an organic-organic composite material, intended to be used in such a battery. The invention also relates to a process for manufacturing such an electrolyte. This electrolyte is notably intended for making a lithium-polymer battery or an “all-solid” battery, notably as regards the ion-conducting separator. The invention thus also relates to a battery separator comprising such a polymer electrolyte, to processes for manufacturing same and to the battery incorporating this electrolyte.

### TECHNICAL CONTEXT

The usual lithium-ion batteries comprise flammable liquid electrolytes based on solvents and lithium salts. Given the increasing use of batteries of this type in the field of electronic consumer products such as computers, tablets or mobile phones (smartphones), but also in the field of transportation notably with electric vehicles, improving the safety and reducing the manufacturing cost of these lithium batteries have become major challenges.

To solve this problem, lithium-polymer batteries comprising solid polymer electrolytes (also known as SPEs), in replacement for flammable liquid electrolytes, have been studied in recent years. Solid polymer electrolytes SPEs, without liquid solvent, thus avoid the use of flammable liquid components as in conventional Li-ion batteries and allow the production of thinner and more flexible batteries.

Despite their low intrinsic ion conductivity, SPEs have shown great potential both for small-sized applications, such as three-dimensional microbatteries, for example, and for large-scale energy storage applications, such as for electric vehicles.

Currently, the polymers most commonly used as solid polymer electrolytes are polyethers, for instance poly(ethylene oxide), also known as PEO. However, these polymers have the drawback of crystallizing readily, especially at temperatures close to room temperature, which has the effect of very significantly reducing the ion conductivity of the polymer. This is why these polymers allow use of the battery into which they are inserted only at a minimum temperature of 60° C. However, it would be convenient to be able to use such a battery at room temperature and even at negative temperature. Furthermore, these PEOs are highly hydrophilic and have a tendency to plasticize, especially in the presence of lithium salts, which reduces their mechanical stability.

Aliphatic polycarbonates have also been studied as host polymer matrix for SPEs. To this end, cyclic carbonates may be polymerized by ring opening to create linear macromolecular carbonates in solid form. Such ethylene carbonate polymers have been prepared and successfully used as electrolytes for conducting lithium ions Li⁺, although the stability of 5-membered cyclic carbonates such as ethylene carbonate makes them less ideal candidates for controlled polymerization. The reason for this is that the polymerization of ethylene carbonate is accompanied by decarboxylation, leading to a copolymer of carbonate and of ethylene oxide. [G. Rokicki et al., Prog. Polym. Sci. 25 (2000) 259-342].

The article from D. Brandell, Solid State Ionics 262 (2014) 738-742, describes the preparation of poly(trimethylene carbonate), also known as PTMC, by bulk polymerization, by ring opening of the trimethylene carbonate (TMC) monomer, initiated with tin dioctanoate. The polymer obtained has a molecular mass of 368 000 g/mol, a polydispersity of 1.36 and contains less than 7% of residual monomer. Such a polymer is amorphous and has a relatively low glass transition temperature, of −15° C. Similarly, in the article published in the Journal of Power Sources 298 (2015) 166-170, D. Brandell et al. also describe that the copolymerization of caprolactone with trimethylene carbonate makes it possible to obtain an amorphous ion-conducting polymer, with a low glass transition temperature, of −63.7° C. However, the polymers described in these documents remain hazardous for use as solid polymer electrolyte for a battery. The reason for this is that the large amount of residual monomer presents a risk of flammability. Finally, the polymers described in these two documents have number-average molecular masses that are much higher than 100 000 g/mol to avoid mechanical stability problems, notably in electrodes, so that they do not become detached from the metallic current collector. However, the higher the molecular mass of the polymer, the more detrimental this is to the mobility of its chains and its ion conductivity.

Selective polymerization methods, of controlled and living nature, making it possible, via organocatalysis, to obtain polyesters and polycarbonates that may or may not be copolymerized, were moreover developed. In this case, the organocatalyst is organic, such as MSA (methanesulfonic acid) or TfOH (trifluoromethanesulfonic acid), i.e. the polymerization takes place without the introduction of metal derivatives, such as tin salts.

Methanesulfonic acid (MSA) has proven to be very efficient in the polymerization of F-caprolactone (s-CL) or trimethylene carbonate (TMC), and trifluoromethanesulfonic acid (TfOH) is an organic catalyst of choice for performing the controlled polymerization of β-butyrolactone (BBL).

WO 2008/104723 and WO 2008/10472 and also the paper entitled “Organo-catalyzed ROP of F-caprolactone: methanesulfonic acid competes with trifluoromethanesulfonic acid”, Macromolecules, 2008, volume 41, pages 3782-3784, notably demonstrated the efficiency of methanesulfonic acid as catalyst for the polymerization of F-caprolactone. Said documents also describe that, in combination with a protic initiator of alcohol type, MSA is capable of promoting the controlled polymerization of the F-caprolactone cyclic monomer. In particular, the protic initiator allows fine control of the mean molar masses and also of the chain ends.

Oligomers having high ion conductivity are known, but they have no mechanical strength. Low glass transition temperatures (Tg) are sought to improve the conductivity, but this occurs at the expense of the mechanical properties. Conversely, when they are better, it is either because the molar mass has increased, or because the polymer presents crystallinity.

The Applicant thus sought a solution for preparing a solid polymer electrolyte with satisfactory ion conductivity even at low temperature, i.e. at room temperature and even at a negative temperature, typically at a temperature between +60° C. and −20° C., and, to do this, it chose to separate the mechanical functions and the conduction functions.

The aim of the invention is thus to overcome at least one of the drawbacks of the prior art. The invention is notably directed toward proposing a solid polymer electrolyte which is of satisfactory ion conductivity even at low temperature, below 60° C. and which may go down to −20° C.

To do this, the conductive part of the electrolyte must have the smallest possible crystallinity and a glass transition temperature below the operating temperature of the battery for which it is intended. The polymer electrolyte material must also make it possible to prepare electrodes that afford good cohesion of the particles, and also good adhesion to the current collector.

The polymer electrolyte material must also make it possible to prepare a separator which has satisfactory electrochemical stability (potential as a function of the cathode material used), and satisfactory ion conductivity over the envisaged working temperature range.

The invention is also directed toward proposing a process for synthesizing such a material, which is quick, simple and inexpensive to implement.

### SUMMARY OF THE INVENTION

According to a first aspect, the invention relates to a solid polymer electrolyte intended to be used in a battery functioning at a temperature below 60° C., said electrolyte comprising:
a thermoplastic polymer in the form of a porous film, said polymer having a molecular mass of greater than 50 000 g/mol,
an oligomer impregnating said thermoplastic polymer film, this oligomer being an ion conductor, and
one or more lithium salts.

According to one embodiment, the thermoplastic polymer is a compound of general formula: —[(CR₁R₂—CR₃R₄)—]ₙ in which R₁, R₂, R₃ and R₄ are independently H, F, CH₃, Cl, Br or CF₃, it being understood that at least one of these radicals is F or CF₃.

According to one embodiment, the thermoplastic polymers are characterized by piezoelectric, ferroelectric, pyroelectric or relaxor ferroelectric properties.

The thermoplastic polymer included in the solid polymer electrolyte composition is prepared in the form of a porous film.

The process for preparing said porous film comprises the following steps:
the provision of an ink comprising the thermoplastic polymer and a vehicle comprising a solvent for said polymer and a nonsolvent for said polymer, said solvent and said nonsolvent being mutually miscible;
the deposition of the ink on a substrate;
the evaporation of the vehicle comprising the solvent and the nonsolvent.

The solid polymer electrolyte according to the invention comprises an oligomer which impregnates the thermoplastic polymer film. According to one embodiment, this ion-conducting oligomer bears at least one group which has physical or chemical affinity with the thermoplastic polymer.

The invention also relates to a separator for a lithium-polymer battery, said separator being characterized in that it comprises the solid polymer electrolyte described above.

Another subject of the invention is a lithium-polymer battery comprising a separator based on the solid polymer electrolyte described above, arranged between an anode consisting of lithium metal and a cathode.

According to another aspect, the invention relates to a lithium battery comprising a stack of layers, said stack comprising an anode preferentially consisting of lithium metal, a cathode and a separator, said battery being characterized in that said separator comprises a solid polymer electrolyte as described above.

The present invention makes it possible to overcome the drawbacks of the prior art. The invention more particularly provides solid polymer electrolytes which have satisfactory ion conductivity even at low temperature.

This is achieved via the implementation of an organic-organic composite polymer material consisting of a porous film of semicrystalline thermoplastic polymer, which is impregnated with an ion-conducting oligomer bearing at least one function with affinity for the thermoplastic polymer.

This type of polymer electrolyte is manufactured according to a very simple, rapid and inexpensive process. It merely involves dissolution, drying and impregnation operations which may be performed at very moderate temperatures.

The ion conductivity of a polymer electrolyte is proportionately higher when the measurement is taken at a temperature that is remote from and above the glass transition temperature of the thermoplastic polymer. Given the fact that the thermoplastic polymer backbone makes it possible to conserve the mechanical strength, the conduction and mechanical strength (mechanical modulus) functions are dissociated.

The solid polymer electrolyte of the invention ensures mechanical stability during the charging/discharging cycles of the battery, making it possible to conserve the cohesion of the electrode during the volume variations associated with the insertion/deinsertion of lithium, without compromising the ion conductivity with excessively long chains. Hitherto, to solve this size stability problem, notably with PEOs, it was necessary to produce polymers bearing very long chains and to ensure the mechanical stability of the electrode. However, this increase in the molecular mass of the polymer takes place at the expense of the mobility of its chains and of its ion conductivity.

Given the dissociation of the mechanical and conduction functions, no further limitations appear due to these considerations.

### DESCRIPTION OF EMBODIMENTS OF THE INVENTION

The invention is described in further detail below.

The invention relates to a solid polymer electrolyte intended to be used in a battery functioning at a temperature below 60° C., said electrolyte comprising:
a thermoplastic polymer in the form of a porous film, said polymer having a molecular mass of greater than 50 000 g/mol,
an oligomer impregnating said thermoplastic polymer film, this oligomer being an ion conductor, and
one or more lithium salts.

Thermoplastic Polymer Film

The term “polymer” means a macromolecule consisting of a sequence of one or more monomers connected to each other via covalent bonds; this term covers herein homopolymers, copolymers consisting of two different constituent units and copolymers consisting of three or more different constituent units. The term “thermoplastic polymer” as used refers to a polymer that turns into a flowable, liquid or pasty fluid when heated and that can take on new shapes by the application of heat and pressure. The thermoplastic polymer of the invention may be amorphous or semicrystalline.

Advantageously, the thermoplastic polymer has good mechanical properties and can be crosslinked. The term “good mechanical properties” means a Young's modulus at the maximum working temperature of at least 1 MPa, preferably of at least 10 MPa.

The thermoplastic polymer has a number-average molecular mass of greater than 50 000 g/mol. According to one embodiment, the thermoplastic polymer has a number-average molecular mass of greater than 100 000 g/mol and preferably greater than 200 000 g/mol. The molecular weight can also be evaluated by measurement of the melt flow index (10 minutes) at 230° C. under a load of 10 kg according to ASTM D1238 (ISO 1133). The MFI measured under these conditions may be between 0.2 and 20 g/10 minutes and preferably between 0.5 and 10 g/10 minutes.

According to one embodiment, the thermoplastic polymer is a compound of general formula: —[(CR₁R₂—CR₃R₄)—]ₙ in which R₁, R₂, R₃ and R₄ are independently H, F, CH₃, Cl, Br or CF₃, it being understood that at least one of these radicals is F or CF₃.

According to one embodiment, said thermoplastic polymer is a homopolymer of said monomer —(CR₁R₂—CR₃R₄)—. According to one embodiment, said thermoplastic polymer is the following homopolymer: [—(CH₂—CF₂)—]ₙ.

According to one embodiment, said thermoplastic polymer is a copolymer bearing two different constituent units or a terpolymer bearing three different constituent units or a copolymer bearing four or more different constituent units comprising units derived from said monomer and units derived from at least one other comonomer. These copolymers bearing at least two different constituent units are random or block copolymers. In the text hereinbelow, the term “copolymer” will be used to denote any copolymer consisting of at least two different constituent units.

According to one embodiment, the fluoropolymer is a polymer comprising units obtained from vinylidene fluoride (VDF) and also units obtained from at least one other monomer of formula CX₁X₂═CX₃X₄, in which each group from among X₁, X₂, X₃ and X₄ is independently chosen from H, Cl, F, Br, I and alkyl groups comprising from 1 to 3 carbon atoms, which are optionally partially or totally halogenated; and preferably the fluoropolymer comprises units obtained from vinylidene fluoride and from at least one monomer chosen from trifluoroethylene (TrFE), tetrafluoroethylene, chlorotrifluoroethylene (CTFE), 1,1-chlorofluoroethylene, hexafluoropropene, 3,3,3-trifluoropropene, 1,3,3,3-tetrafluoropropene, 2,3,3,3-tetrafluoropropene, 1-chloro-3,3,3-trifluoropropene and 2-chloro-3,3,3-trifluoropropene; and more preferably the fluoropolymer is chosen from poly(vinylidene fluoride-co-hexafluoropropene), poly(vinylidene fluoride-co-trifluoroethylene), poly(vinylidene fluoride-ter-trifluoroethylene-ter-chlorotrifluoroethylene) and poly(vinylidene fluoride-ter-trifluoroethylene-ter-1,1-chlorofluoroethylene).

Preferably, the thermoplastic polymers or copolymers are semicrystalline with degrees of crystallinity of between 10% and 90% and preferably between 20% and 70%.

According to one embodiment, these thermoplastic polymers are characterized in that they have piezoelectric, ferroelectric, pyroelectric or relaxor ferroelectric properties.

According to one embodiment, such polymers are P(VDF-TrFE) copolymers, the VDF/TrFE mole ratio of the structural units being between 9 and 0.1, and preferably being between 4 and 1.

A preferred example of copolymers are those of formula P(VDF-TrFE) and having an 80/20 molar composition, which have a relative dielectric permittivity of the order of 9-12 measured at a frequency of 1 kHz and at room temperature.

According to another embodiment, such polymers are P(VDF-TrFE-CTFE) terpolymers in which the molar content of VDF ranges from 40% to 95%, the molar content of TrFE ranges from 5% to 60% and the molar content of CTFE ranges from 0.5% to 20%.

A preferred example of terpolymers are those with a molar composition of 65/31/4 with a melting point (m.p.) of 130° C. and a relative dielectric permittivity equal to 60 at 50° C. and 1 kHz.

The thermoplastic polymer included in the solid polymer electrolyte composition is prepared in the form of a porous film. Several techniques are possible to do this, but the Applicant favored the solvent/nonsolvent route.

The manufacture of the porous film of the invention includes the following steps:
the provision of an ink comprising the thermoplastic polymer and a vehicle comprising a solvent for said polymer and a nonsolvent for said polymer, said solvent and said nonsolvent being mutually miscible;
the deposition of the ink on a substrate;
the evaporation of the vehicle comprising the solvent and the nonsolvent.

These last two steps are performed at room temperature or close to room temperature, until a solid film has formed. The deposition or coating processes are preferably coatings performed: by centrifugation (spin coating), by spraying or atomization (spray coating), by coating notably with a bar or a film spreader (bar coating), by coating with a slot die (slot-die coating), by immersion (dip coating), by roll printing (roll-to-roll printing), by screen printing, by flexographic printing, by lithographic printing or by inkjet printing.

The nonsolvent is chosen from the group consisting of benzyl alcohol, benzaldehyde or a mixture thereof.

The solvent is chosen from the group consisting of ketones, esters, notably cyclic esters, dimethyl sulfoxide, phosphoric esters such as triethyl phosphate, carbonates, ethers such as tetrahydrofuran, and a mixture thereof, the solvent preferably being chosen from the group consisting of ethyl acetate, methyl ethyl ketone, γ-butyrolactone, triethyl phosphate, cyclopentanone, propylene glycol monomethyl ether acetate and a mixture thereof.

According to one embodiment, the solvent is γ-butyrolactone and the nonsolvent is benzyl alcohol, or the solvent is ethyl acetate and the nonsolvent is benzyl alcohol, or the solvent is methyl ethyl ketone and the nonsolvent is benzyl alcohol.

The porous film thus obtained includes pores with a mean diameter of from 0.1 to 10 μm, preferably from 0.2 to 5 μm, more preferably from 0.3 to 4 μm. The mean pore diameter may be measured by scanning electron microscopy.

In terms of operations for the actual preparation of said porous membranes, the above approach only includes the preparation of the ink, its deposition and its drying, after which the porous membrane is made. This method has the advantage of not requiring precipitations from water, which is a compound that can degrade the performance qualities of the membranes for electronic applications.

Ion-Conducting Oligomer

The solid polymer electrolyte according to the invention comprises an oligomer which impregnates the thermoplastic polymer film.

An oligomer, or oligomeric molecule, is an intermediate compound between a monomer and a polymer, the structure of which is essentially comprises a small plurality of monomer units. An oligomer generally has a number of monomer units ranging from 5 to 100 and/or a number-average molecular mass of less than or equal to 5000 g/mol. The number of monomer units is usually less than 50, or even 30. The number-average molecular mass may notably be less than 4000 g/mol, or 3000 g/mol, or even 2000 g/mol.

This oligomer is an ion conductor, i.e. it advantageously has an ion conductivity of at least 0.1 mS/cm at 25° C. in the presence of an Li salt. It is necessarily in pure liquid form or must be dissolved in a solvent. According to one embodiment, the ion-conducting oligomer bears a function which has affinity for the thermoplastic polymer. According to one embodiment, the oligomer advantageously comprises the group —CR₂—O, where R is: H, alkyl, aryl or alkenyl, the preferred group being H.

According to one embodiment, the oligomer bears at least one group of polyethylene glycol (PEG) type. Among these oligomers, methoxy polyethylene glycol methacrylates are advantageous. One of these products, SR 550 from Sartomer, is shown below:

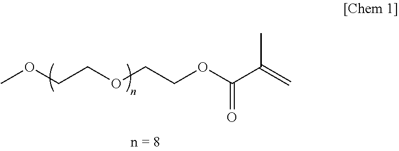

Solid Polymer Electrolyte

The solid polymer electrolyte has a satisfactory ion conductivity of at least 0.1 mS/cm, at 25° C.

In addition to the thermoplastic polymer film and the oligomer, it contains one or more lithium salts.

The electrolytic salts, which are dissolved in the oligomer, are chosen from at least one of the following salts, when the technology is lithium-based technology: lithium hexafluorophosphate (LiPF₆); lithium perchlorate (LiClO₄); lithium hexafluoroarsenate (LiAsF₆); lithium tetrafluoroborate (LiBF₄); lithium 4,5-dicyano-2-(trifluoromethyl)imidazol-1-ide (LiTDI); lithium bis(fluorosulfonyl)imide (LiFSI); lithium bis-trifluoromethanesulfonimide (LiTFSI); lithium N-fluorosulfonyl-trifluoromethanesulfonylamide (Li-FTFSI); lithium tris(fluorosulfonyl)methide (Li-FSM); lithium bis(perfluoroethylsulfonyl)imide (LiBETI); lithium bis(oxalato)borate (LiBOB); lithium difluoro(oxalate)borate (LiDFOB); lithium 3-polysulfide sulfolane (LiDMDO), or mixtures thereof.

In the solid polymer electrolyte according to the invention, the thermoplastic polymer is present in an amount ranging from 10% to 90%, preferably from 20% to 80%, and the oligomer is present in an amount ranging from 90% to 10%, preferably from 80% to 20%, based on the total weight of the solid polymer electrolyte.

The invention also relates to a process for manufacturing the polymer electrolyte, characterized in that it consists in dissolving the lithium salt(s) in the conductive oligomer and then in impregnating the thermoplastic polymer film with this solution.

The thermoplastic polymer may or may not be crosslinked. In the case of crosslinking, this is performed thermally using crosslinking agents such as free-radical generators, among which mention may be made of azo compounds, for instance azobisisobutyronitrile (AIBN) or peroxides, for instance Luperox® 26.

The invention also relates to a separator for a lithium-polymer battery, said separator being characterized in that it comprises the solid polymer electrolyte described above.

According to one embodiment, in the separator, the solid polymer electrolyte is deposited on a porous support such as cellulose, polyolefins or polyacrylonitrile. Its thickness is between 4 and 50 microns, preferentially between 7 and 35 microns and even more preferentially between 10 and 20 microns.

According to one embodiment, the separator may also include up to 50% by mass of inorganic particles.

According to one embodiment, these particles are chosen from conductive ceramics, such as sulfur-based ceramics Li₂S-P₂S₅ (mole ratio between Li₂S and P₂S₅ of between 1 and 3) and derivatives thereof, perovskites (of normal type A^{II}B^{IV}O₃) of lacunar type Li₃ₓLa_{2/3-x}TiO₃ which may be doped with Al, Ga, Ge or Ba, garnets of the type Li₇La₃Zr₂O₁₂ which may be doped with Ta, W, Al or Ti, ceramics of NASICON type LiGe₂(PO₄)₃ or LiTi₂(PO₄)₃ which may be doped with Ti, Ge, Al, P, Ga or Si, and anti-perovskites of the type Li₃OCl or Na₃OCl which may be doped with OH or Ba.

According to one embodiment, these particles are chosen from fillers that are intrinsically nonconductive or intrinsically very sparingly conductive at room temperature, such as silicas, aluminas, titanium oxides, zirconium oxides, and mixtures thereof.

According to one embodiment, these particles are chosen from fillers with relative permittivities of greater than 2000, such as barium, strontium and lead titanates, lead zirconates, zirconium and lead titanates, and mixtures thereof.

The separator may contain other additives, such as agents which facilitate the mobility of the conductive chains, in particular succinonitrile.

Another subject of the invention is a lithium-polymer battery comprising a separator based on the solid polymer electrolyte described above, arranged between an anode consisting of lithium metal and a cathode.

According to another aspect, the invention relates to a lithium battery comprising a stack of layers, said stack comprising an anode preferentially consisting of lithium metal, a cathode and a separator.

The cathode is composed of:
an electrochemically active material: between 35% and 98% by mass. More particularly, the electrochemically active material is chosen, without limitation, from at least one of the following materials: lithiated iron phosphate (LFP); lithiated nickel manganese cobalt (NMC) oxide; lithiated nickel cobalt aluminum (NCA) oxide; lithiated manganese oxide (LMO); lithiated nickel manganese (LM) oxide; lithiated cobalt oxide (LCO), sulfur; or a mixture thereof. The sparingly conductive materials such as iron or manganese phosphates can be covered with a layer of carbon to improve the electron conduction;
conductive additives: between 0.15% and 25% by mass, chosen from at least one of the following carbon-based fillers: carbon black; single-wall or multi-wall carbon nanotubes; carbon nanofibers; graphites; graphenes; fullerenes; or a mixture thereof;
a polymer electrolyte: between 20% and 60% by mass;
optionally, a polymer to bind the particles together and to improve the mechanical strength and the adhesion to the collector: between 0 and 5% by mass, chosen from at least one of the following binders: poly(vinylidene fluoride) (PVDF) and derivatives and copolymers thereof; carboxymethylcellulose (CMC); styrene-butadiene rubber (SBR); poly(ethylene oxide) (PEO); poly(propylene oxide) (PPO); polyglycols; or a mixture thereof.

The current collector of such a cathode is made of aluminum, carbon-coated aluminum or carbon.

The anode is composed of:
electrochemically active material, which may be treated lithium metal, graphite, lithiated titanium oxide (LTO), silicon, silicon-carbon composites, or graphene. The active material may be covered with the carbon to improve the electron conduction;
conductive additives: present at between 0.15% and 25% by mass, chosen from at least one of the following carbon-based fillers: carbon black; single-wall or multi-wall carbon nanotubes; carbon nanofibers; graphites; graphenes; fullerenes; or a mixture thereof,
a polymer electrolyte: between 15% and 60% by mass.

The current collector of such an anode is made of copper, carbon or nickel, but for the Li-metal technology, it is envisaged that the Li foil is its own collector.

The conductive additives included in the constitution of the anode and/or of the cathode may be chosen from carbon-based fillers. According to the invention, the term “carbon-based filler” means a filler comprising an element from the group formed from carbon nanotubes, carbon nanofibers, graphene, fullerenes and carbon black, or a mixture thereof in any proportion. According to the invention, the term “graphene” means a flat, isolated and separate graphite sheet but also, by extension, an assembly comprising between one and a few dozen sheets and having a flat or more or less wavy structure. This definition thus encompasses FLGs (Few Layer Graphene), NGPs (Nanosized Graphene Plates), CNSs (Carbon NanoSheets) and GNRs (Graphene NanoRibbons). On the other hand, it excludes carbon nanotubes and nanofibers, which are constituted, respectively, of the rolling up of one or more graphene sheets coaxially and of the turbostratic stacking of these sheets, and graphite, which is constituted of an assembly comprising more than a few dozen sheets.

Preferably, the carbon-based fillers are carbon nanotubes, alone or as a mixture with graphene.

The carbon nanotubes (CNT) may be of the single-wall type (SWCNT), double-wall type or multi-wall type (MWCNT). The double-wall nanotubes may notably be prepared as described by Flahaut, E. et al, “Gram-scale CCVD synthesis of double-walled carbon nanotubes.” (2003) Chemical Communications (No. 12) pages 1442-1443. Multi-wall nanotubes may for their part be prepared as described in WO 03/02456. Nanotubes usually have a mean diameter ranging from 0.1 to 100 nm, preferably from 0.4 to 50 nm and better still from 1 to 30 nm, or even from 10 to 15 nm, and advantageously have a length of from 0.1 to 10 μm. Their length/diameter ratio is preferably greater than 10 and usually greater than 100. Their specific surface area is, for example, between 100 and 300 m²/g, advantageously between 200 and 300 m²/g, and their apparent density may notably be between 0.05 and 0.5 g/cm³ and more preferentially between 0.1 and 0.2 g/cm³. Multi-wall nanotubes may comprise, for example, from 5 to 20 sheets (or walls) and more preferentially from 7 to 10 sheets.

An example of raw carbon nanotubes is notably commercially available from the company Arkema under the trade name Graphistrength® C100. Alternatively, these nanotubes may be purified and/or treated (for example oxidized) and/or ground and/or functionalized, before being used in the process according to the invention. The raw or ground nanotubes can be purified by washing using a sulfuric acid solution, so as to free them from any residual mineral and metallic impurities. The purification may be performed by heat treatment at high temperature (above 2200° C.) under an inert atmosphere. The oxidation of the nanotubes is advantageously performed by placing them in contact with a sodium hypochlorite solution or by exposure to atmospheric oxygen at a temperature of 600-700° C. The functionalization of the nanotubes may be performed by grafting reactive units such as vinyl monomers onto the surface of the nanotubes.

The graphene used may be obtained by chemical vapor deposition or CVD, preferably according to a process using a pulverulent catalyst based on a mixed oxide. It is characteristically in the form of particles having a thickness of less than 50 nm, preferably of less than 15 nm and more preferentially of less than 5 nm, and having lateral dimensions of less than a micron, from 10 to 1000 nm, preferentially from 50 to 600 nm and more preferentially from 100 to 400 nm. Each of these particles generally contains from 1 to 50 sheets, preferably from 1 to 20 sheets and more preferentially from 1 to 10 sheets. Various processes for preparing graphene have been proposed in the literature, including processes known as mechanical exfoliation and chemical exfoliation, consisting in peeling off graphite sheets in successive layers by means, respectively, of an adhesive tape (Geim A. K, Science, 306: 666, 2004) or by using reagents such as sulfuric acid combined with nitric acid, intercalated between the graphite sheets and oxidizing them, so as to form graphite oxide which can be readily exfoliated in water in the presence of ultrasound. Another exfoliation technique consists in subjecting graphite in dispersion to ultrasound, in the presence of a surfactant (U.S. Pat. No. 7,824,651). Graphene particles may also be obtained by cleaving carbon nanotubes along the longitudinal axis (“Micro-Wave Synthesis of Large Few-Layer Graphene Sheets in Aqueous Solution of Ammonia”, Janowska, I. et al., NanoResearch, 2009 or “Narrow Graphene Nanoribbons from Carbon Nanotubes”, Jiao L. et al., Nature, 458: 877-880, 2009). Yet another method for preparing graphene consists of the high-temperature decomposition of silicon carbide under vacuum. Finally, several authors have described a process for synthesizing graphene by chemical vapour deposition (CVD), optionally combined with a radio frequency generator (RF-CVD) (Dervishi et al., J. Mater. Sci., 47: 1910-1919, 2012).

Fullerenes are molecules composed exclusively or virtually exclusively of carbons which may take a geometrical shape resembling that of a sphere, an ellipsoid, a tube (known as a nanotube) or a ring. Fullerenes may be selected, for example, from: C60 fullerene, which is a compound of spherical shape formed from 60 carbon atoms, C70, PCBM of formula methyl [6,6]-phenyl-C61-butyrate, which is a fullerene derivative whose chemical structure has been modified to make it soluble, and PC 71-BM of formula methyl [6,6]-phenyl-C71-butyrate.

Carbon nanofibers are, like the carbon nanotubes, nanofilaments produced by chemical vapor deposition (or CVD) starting from a carbon-based source which is decomposed on a catalyst including a transition metal (Fe, Ni, Co, Cu), in the presence of hydrogen, at temperatures of 500° C. to 1200° C. Carbon nanofibers are composed of more or less organized graphite regions (or turbostratic stacks), the planes of which are inclined at variable angles relative to the axis of the fiber. These stacks may take the form of platelets, fishbones or stacked dishes to form structures having a diameter generally ranging from 100 nm to 500 nm or even more. Carbon nanofibers with a diameter of 100 to 200 nm, for example about 150 nm (VGCF® from Showa Denko), and advantageously a length of 100 to 200 μm are preferred in the process according to the invention.

Moreover, a carbon-based filler that may be used is carbon black, which is a colloidal carbon-based material manufactured industrially by incomplete combustion of heavy petroleum products and which is in the form of carbon spheres and of aggregates of these spheres, the dimensions of which are generally between 10 and 1000 nm.

Very advantageously, these conductive additives are added to the composition of each electrode with a content of between 0.25% and 25% by mass.

### EXAMPLES

The examples that follow illustrate the invention without limiting it.

### Example 1

A p(VDF-TrFE) copolymer film is prepared by dissolving 10 g of FC 20 copolymer from Piezotech in a solvent mixture consisting of 75 g of γ-butyrolactone and 15 g of benzyl alcohol, and is then deposited on a glass slide and 4 cm×2 cm of the film obtained, i.e. 0.0664 g, is left to dry; this film is then impregnated with 0.097 g of SR 550 into which 23.1 mg of LiTFSI have previously been dissolved, in a glovebox. This amount corresponds to EO/Li=13.

In less than 30 seconds, the SR 550 is absorbed into the porosity. The film is then left overnight in an oven at 50° C.

### Example 2

The operation of example 1 is repeated for a ratio EO/Li=17.

### Example 3

The operation of example 1 is repeated for a ratio EO/Li=25.

### Example 4

The ion conductivity is determined by electrochemical impedance spectroscopy. The materials are placed between two stainless-steel electrodes (measured thickness of the order of 100 μm) inside a leaktight cell. The preparation of the films and the assembly of the cell are performed in a glovebox under an argon atmosphere. The cell is maintained at 80° C. for 1 hour so as to ensure good contact between the sample and the stainless-steel electrodes. The actual measurement is performed using an EIS Bio-Logic VMP3 potentiostat/galvanostat between 1 Hz and 1 MHz at an amplitude of 500 mV.

The values found for the three examples are reported in table 1 below. It is found that the values depend little on the EO/Li ratio, which is an advantage as regards industrial extrapolation.

TABLE 1

| Molar EO/Li | Ion conductivity (mS/cm) at 25° C. |
|---|---|
| 13 | 0.16 |
| 17 | 0.17 |
| 25 | 0.13 |

### Example 5

The electrochemical stability represents the capacity of an electrolyte to withstand electrochemical decomposition. The electrochemical stability measurements were performed in CR2032 format button cells (two electrodes) at 60° C., using SUS 316L stainless steel as working surface on an area of 2.01 cm² on a sample of copolymer film prepared according to example 2.

The electrochemical method used is slow cyclic voltammetry performed with a sweep speed of 1 mV/s. This method illustrates the oxidation current as a function of the voltage: each time the current approaches zero, the operating voltage of the polymer electrolyte is stable. The electrochemical stability is equal to 4.5 V. The curve I=f (V) is perfectly flat down to 0 V.

1. A solid polymer electrolyte for a battery operating at a temperature below 60° C., said electrolyte comprising:
a thermoplastic polymer in the form of a porous film, said polymer having a molecular mass of greater than 50,000 g/mol,
an oligomer impregnating said thermoplastic polymer film, this oligomer being an ion conductor, and
one or more lithium salts.

2. The solid polymer electrolyte as claimed in claim 1, in which the thermoplastic polymer is a compound of general formula: —[(CR₁R₂—CR₃R₄)—]ₙ in which R₁, R₂, R₃ and R₄ are independently H, F, CH₃, Cl, Br or CF₃, at least one of these radicals being F or CF₃.

3. The solid polymer electrolyte as claimed in claim 1, in which the thermoplastic polymer is a fluoropolymer chosen from poly(vinylidene fluoride-co-hexafluoropropene), poly(vinylidene fluoride-co-trifluoroethylene), poly(vinylidene fluoride-ter-trifluoroethylene-ter-chlorotrifluoroethylene) and poly(vinylidene fluoride-ter-trifluoroethylene-ter-1,1-chlorofluoroethylene).

4. The solid polymer electrolyte as claimed in claim 1, in which the thermoplastic polymer is a P(VDF-TrFE) copolymer in which the VDF/TrFE mole ratio of the structural units ranges from 9 to 0.1.

5. The solid polymer electrolyte as claimed in claim 1, in which the thermoplastic polymer is a P(VDF-TrFE-CTFE) terpolymer in which the molar content of VDF ranges from 40% to 95%, the molar content of TrFE ranges from 5% to 60% and the molar content of CTFE ranges from 0.5% to 20%.

6. The solid polymer electrolyte as claimed in claim 1, in which the oligomer comprises the group —CR₂—O, in which R is: H, alkyl, aryl or alkenyl.

7. The solid polymer electrolyte as claimed in claim 6, in which the oligomer bears at least one group of polyethylene glycol type.

8. The solid polymer electrolyte as claimed in claim 1, a comprising one or more lithium salts chosen from lithium hexafluorophosphate (LiPF₆); lithium perchlorate (LiClO₄); lithium hexafluoroarsenate (LiAsF₆); lithium tetrafluoroborate (LiBF₄); lithium 4,5-dicyano-2-(trifluoromethyl)imidazol-1-ide (LiTDI); lithium bis(fluorosulfonyl)imide (LiFSI); lithium bis-trifluoromethanesulfonimide (LiTFSI); lithium N-fluorosulfonyl-trifluoromethanesulfonylamide (Li-FTFSI); lithium tris(fluorosulfonyl)methide (Li-FSM); lithium bis(perfluoroethylsulfonyl)imide (LiBETI); lithium bis(oxalato)borate (LiBOB); lithium difluoro(oxalate)borate (LiDFOB); lithium 3-polysulfide sulfolane (LiDMDO), or mixtures thereof.

9. The solid polymer electrolyte as claimed in claim 1, in which the thermoplastic polymer is present in an amount ranging from 10% to 90%, and the oligomer is present in an amount ranging from 90% to 10%, based on the total weight of the solid polymer electrolyte.

10. The solid polymer electrolyte as claimed in claim 1, in which the porous film of thermoplastic polymer is manufactured according to a process including the following steps:
the provision of an ink comprising the thermoplastic polymer and a vehicle comprising a solvent for said polymer and a nonsolvent for said polymer, said solvent and said nonsolvent being mutually miscible;
the deposition of the ink on a substrate;
the evaporation of the vehicle comprising the solvent and the nonsolvent.

11. The solid polymer electrolyte as claimed in claim 1, which has an ion conductivity of at least 0.1 mS/cm at 25° C.

12. The solid polymer electrolyte as claimed in claim 1, in which the pores of the thermoplastic polymer film have a mean diameter of from 0.1 to 10 μm, measured by scanning electron microscopy.

13. The solid polymer electrolyte as claimed in claim 1, in which said oligomer has a number-average molecular mass of less than or equal to 5000 g/mol.

14. A process for manufacturing the solid polymer electrolyte as claimed in claim 1, wherein it consists in dissolving the lithium salt(s) in the conductive oligomer and then in impregnating the thermoplastic polymer film with this solution.

15. A separator for a lithium-polymer battery, wherein it comprises the solid polymer electrolyte as claimed in claim 1.

16. The separator as claimed in claim 15, also comprising up to 50% by mass of inorganic particles, said particles being chosen from conductive ceramics, fillers which are intrinsically nonconductive or very sparingly conductive at room temperature and fillers with relative permittivities of greater than 2000.

17. A lithium-polymer battery comprising an anode consisting of lithium metal, a cathode and a separator arranged between the two electrodes, wherein the separator comprises the solid polymer electrolyte as claimed in claim 1.
